(19) United States
(12) Patent Application Publication
(10) Pub. No.: US 2015/0083731 A1
(43) Pub. Date: Mar. 26, 2015

(54) Advanced Insert Liners

(71) Applicant: George Skopis, Glenview, IL (US)

(72) Inventor: George Skopis, Glenview, IL (US)

(21) Appl. No.: 14/541,361

(22) Filed: Nov. 14, 2014

Related U.S. Application Data
(63) Continuation of application No. 13/694,059, filed on Dec. 7, 2012.

(51) Int. Cl. A47J 36/02; A47J 37/10

(52) U.S. Cl. CPC A47J 36/022; A47J 37/108
USPC 220/573.4

(57) ABSTRACT

Disclosed herein are cooking liners of a particular design such that they retain numerous advantages not present in other cooking liners. Advantages include but are not limited to an improved health profile, better sanitation and container clean up. The liner disclosed herein is an advanced, preformed Insert liner without gaps or ribbing that is fitted into the internal basin of a cooking device, such as a baking or frying container. The liner may have an overhanging lip that fits over the top edges of the containers to stabilize the insert liners which contain the food product. By preventing contact between the food and the cooking container sanitation and health issues are improved. Such a design also helps to eliminate food container clean up issues.

### CROSS-REFERENCE TO RELATED APPLICATIONS & CONTINUITY DATA

This application is a continuation application of application Ser. No. 13/694,059 and claims the benefit of application Ser. No. 13/694,059 which is hereby incorporated by reference in its entirety.

### BACKGROUND OF THE INVENTION

Insert liners with gaps in the liners and insert liners larger in size (for example those larger than muffin pan liners) require re-cleaning prior to re-use. Flat liners or mats, do not protect the sides of the cooking containers from contamination, and from coming into contact with food, and the containers require re-cleaning. Slow cooking liners are flanged or ribbed to intentionally release steam while cooking. In this type of cooking process creating a seal that does not release steam is in fact undesirable. These ribbed or flanged liners are designed specifically for the slow cooking process. Disclosed herein is an advanced, preformed Insert liner without gaps or ribbing that is fitted into the internal basin of a cooking device, such as a baking or frying container. The liner has an overhanging lip that fits over the top edges of the containers to stabilize the insert liners which contain the food product. By preventing contact between the food and the cooking container sanitation and health issues are improved. Such a design also helps to eliminate food container clean up issues.

### FIELD OF THE INVENTION

The invention relates to cooking and cooking devices.

### SUMMARY OF THE INVENTION

Disclosed herein are cooking liners of a particular design such that they retain numerous advantages not present in other cooking liners. Advantages include but are not limited to an improved health profile, better sanitation and container clean up. More specifically insert liners with gaps in the liners and insert liners larger in size (for example those larger than muffin pan liners) require re-cleaning prior to re-use. Flat liners or mats, do not protect the sides of the cooking containers from contamination, and from coming into contact with food, and the containers require re-cleaning. Disclosed herein is an advanced, preformed Insert liner without gaps or ribbing that is fitted into the internal basin of a cooking device, such as a baking or frying container. The liner has an overhanging lip that fits over the top edges of the containers to stabilize the insert liners which contain the food product. By preventing contact between the food and the cooking container sanitation and health issues are improved. Such a design also helps to eliminate food container clean up issues.

### BRIEF DESCRIPTION OF THE DRAWINGS FIGURES

FIG. 1: is a perspective view of the invention's square embodiment.

FIG. 2: is an exploded view of the invention's square embodiment.

FIG. 3: is a view of the invention's rectangular embodiment.

FIG. 4 is an exploded view of the invention's rectangular embodiment.

FIG. 5: is a perspective view of the invention's round embodiment.

FIG. 6: is an exploded view of the invention's round embodiment.

FIG. 7: is a perspective view of the invention's oval embodiment.

FIG. 8: is an exploded view of the invention's oval embodiment.

FIG. 9: is a detail section view taken along line 9-9 in FIG. 1.

### DETAILED DESCRIPTION OF THE PREFERRED EMBODIMENTS

Disclosed herein are cooking liners of a particular design such that they retain numerous advantages not present in other cooking liners. Advantages include but are not limited to an improved health profile, better sanitation and container clean up. More specifically insert liners with gaps in the liners and insert liners larger in size (for example those larger than muffin pan liners) require re-cleaning prior to re-use. Flat liners or mats, do not protect the sides of the cooking containers from contamination, and from coming into contact with food, and the containers require re-cleaning. Slow cooking liners are flanged or ribbed to intentionally release steam while cooking. In this type of cooking process creating a seal that does not release steam is in fact undesirable. Disclosed herein is an advanced, preformed Insert liner without gaps or ribbing that is fitted into the internal basin of a cooking device, such as a baking or frying container. The liner has an overhanging lip that fits over the top edges of the containers to stabilize the insert liners which contain the food product. By preventing contact between the food and the cooking container sanitation and health issues are improved. Such a design also helps to eliminate food container clean up issues. The advanced liner herein is is designed to facilitate, or speed up, the cooking process. Through its design it creates a seal that unlike the slow cooking process liners, does not allow the release of steam. Thus when utilized and covered during the cooking process they facilitate a “quicker” cooking time, and to allow for the steam and vapors to integrated into the cooking product for improved taste enhancements

The drawings depict the designs of some of the embodiments according to potential shapes of cooking containers. The figures show how the preformed insert liners fit directly into the containers shown, including the overhang lips. The overhanging lips may not be present in alternative embodiments.

The advanced liners can be made from any number of materials that will be recognized by those skilled in the art. Such materials include but are not limited to cooking acceptable oven papers: aluminum foil, resins, silicone as well as any combination thereof. The continuous gapless once piece advanced insert liners can be produced by machine stamping to size or in a machine molding process, depending on which type of element is being utilized for fabrication or manufacture. This claimed invention differs and is an improvement from what currently exists, in that the advanced insert liners are continuous, without gaps, ribbing, or folds. Additionally they are preformed to fit into a container, and certain embodiments have the overhanging lip that fits over the top edge of the containers to further stabilize, enhance health and sanitation, and facilitate the removal of the advanced liner with the food product. These advanced insert liners differ from, for example, crock pot or slow cooking liners that are made to release steam by ribbing or other such designs made to release steam or vapors; whereas the advanced insert liners form a seal when covered so as not release the steam or vapor, and facilitate a quicker cooking time.

Now turning to the figures and drawings. The drawings depict the designs of some of the embodiments according to potential shapes of cooking containers. The figures show how the preformed insert liners fit directly into the containers shown, including the overhang lips. The figures and the following descriptions depict and describe some embodiments of the current invention and do not represent an exhaustive list. From the figures and particular embodiments shown it is evident that the liners may be made to fit any cooking container, regardless of shape, size, or material. The figures show how the liner is made to fit with near exactness the internal area of the cooking container, as well as provide complete coverage of the container so as to keep food completely separated.

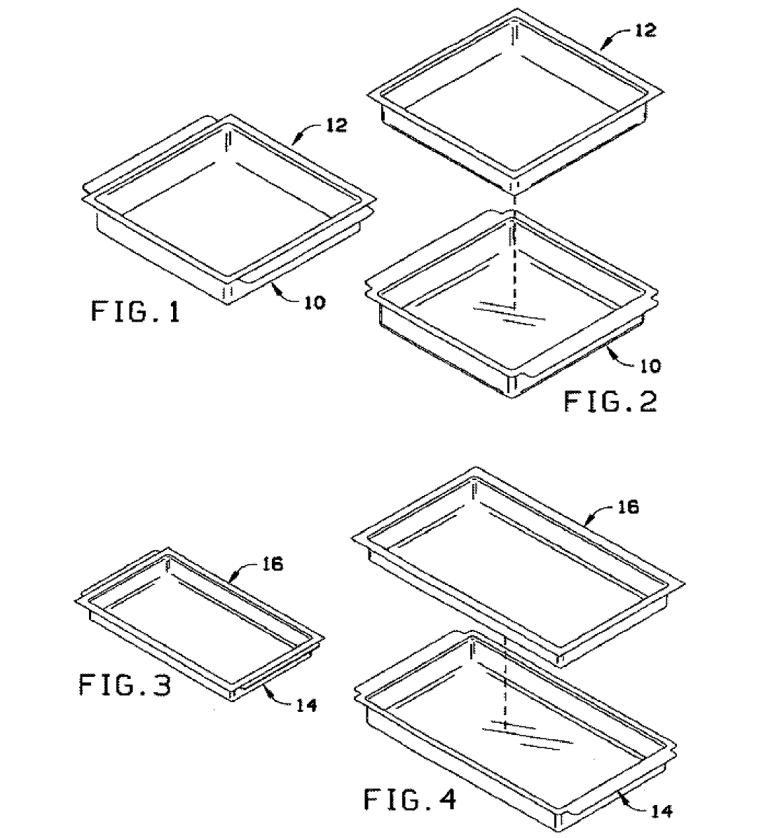

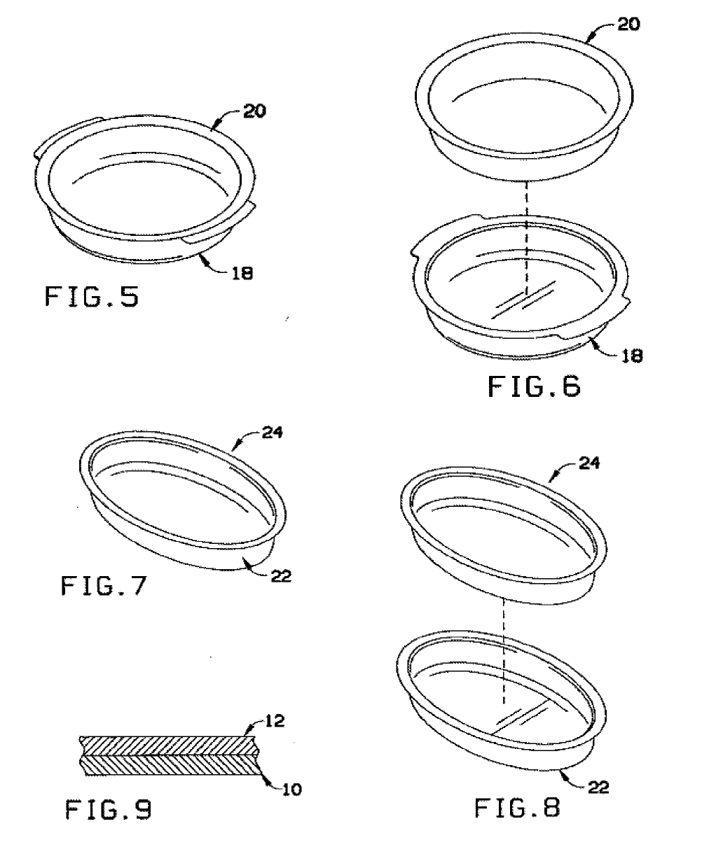

FIG. 1 is a perspective view of the invention's square embodiment. In the FIG. 10: is the square container. 12: is the square liner. FIG. 2 is an exploded view of the invention's square embodiment. In the FIG. 10: is the square container. 12: is the square liner. FIG. 3 is a view of the invention's rectangular embodiment. In the FIG. 14: is the rectangular container. 16: is the rectangular liner. FIG. 4 is an exploded view of the invention's rectangular embodiment. In the FIG. 14: is the rectangular container. 16: is the rectangular liner. FIG. 5 is a perspective view of the invention's round embodiment. In the FIG. 18. is the round container. 20: is the round liner. FIG. 6 is an exploded view of the invention's round embodiment. In the FIG. 18. is the round container. 20: is the round liner. FIG. 7: is a perspective view of the invention's oval embodiment. In the FIG. 22: is the oval container. 24: is the oval liner. FIG. 8 is an exploded view of the invention's oval embodiment. In the FIG. 22: is the oval container. 24: is the oval liner. FIG. 9 is a detail section view taken along line 9-9 in FIG. 1. In this FIG. 10: is the square container. 12: is the square liner.

The phrase “in one embodiment” is used repeatedly. The phrase generally does not refer to the same embodiment; however, it may. The terms “comprising,” “having” and “including” are synonymous, unless the context dictates otherwise. The following illustrations of various embodiments use particular terms by way of example to describe the various embodiments, but this should be construed to encompass and provide for terms such as “method” and “routine” and the like.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

The characteristics and utilities of the present invention described in this summary and the detailed description below are not all inclusive. Many additional features and advantages will be apparent to one of ordinary skill in the art given the following description. There has thus been outlined, rather broadly, the more important features of the invention in order that the detailed description thereof that follows may be better understood, and in order that the present contribution to the art may be better appreciated.

In this respect, by explaining at least one embodiment of the invention in detail, it is to be understood that the invention is not limited in its application to the details of construction and to the arrangements of the components set forth in the description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way. The characteristics and utilities of the present invention described in this summary and the detailed description below are not all inclusive. Many additional features and advantages will be apparent to one of ordinary skill in the art given the detailed description.

1. A cooking insert liner with a smooth body that completely covers the interior of a cooking container is without folds, flanges, indentations, or ribbed surfaces, said liner made from one or more of thin aluminum foil, baking paper, silicone, resin, or graphene material, and wherein the insert liner is oval, circular, rectangular, square in shape, or in the approximate shape of a cooking device to be used.

2. The insert liner of claim 1 wherein the liner may be used for baking, frying, storage, or molding.

3. The insert liner of claim 2 wherein food product is precluded from contacting the surface of the cooking device.

4. The insert liner of claim 3 wherein the liner does not contain an overhang lip.

5. The cooking insert liners of claim 3, wherein the liners are fit to the interior of the cooking containers including an overhang lip, fitting over the top edge portion of a cooking container.

6. The cooking insert liners of claim 5, wherein the liners are larger than muffin pan liners.

7. The insert liner of claim 6, wherein the cooking container is not a slow cooker.

8. The insert liner of claim 4, wherein the cooking container is not a slow cooker.

9. The insert liner of claim 8, wherein the liner is not made of plastic.

10. The insert liner of claim 7, wherein the liner is not made of plastic.

11. The insert liner of claim 9, wherein the liner is made of paper.

12. The insert liner of claim 10, wherein the liner is made of paper.

13. The insert liners of claim 5, wherein the liners by utilizing a smooth and fitting surface create a seal that prevents the release of steam.

14. The insert liners of claim 13 wherein the liners by not releasing steam facilitate a quicker cooking time.

15. The insert liners of claim 14, wherein the liners by not releasing steam increase vapor and moisture absorption improving food flavor.

16. A cooking insert liner that reduces cooking time, said liner having a smooth body that completely covers the interior of a cooking container is without folds, flanges, indentations, or ribbed surfaces, such that a seal is created to prevent the release of steam, said liner made from one or more of thin aluminum foil, baking paper, silicone, resin, or graphene material, and wherein the insert liner is oval, circular, rectangular, square in shape, or in the approximate shape of a cooking device to be used.
